(19) United States
(12) Patent Application Publication
(10) Pub. No.: US 2024/0021943 A1
(43) Pub. Date: Jan. 18, 2024

(54) MODULAR AIRFOIL-SHAPED BATTERY FOR AIRCRAFT

(71) Applicant: Textron Innovations Inc., Providence, RI (US)

(72) Inventors: William A. Amante, Grapevine, TX (US); Tjepke Heeringa, Dallas, TX (US)

(73) Assignee: Textron Innovations Inc., Providence, RI (US)

(21) Appl. No.: 17/812,759

(22) Filed: Jul. 15, 2022

(51) Int. Cl. H01M 50/249; H01M 50/271; H01M 50/233; B60L 53/80; B60L 50/64

(52) U.S. Cl. CPC H01M 50/249; H01M 50/271; H01M 50/233; B60L 53/80; B60L 50/64; H01M 2220/20

(57) ABSTRACT

A modular airfoil-shaped battery disposed in a wing of an aircraft is presented. In one embodiment, the present disclosure provides for a system configured to have batteries or battery modules stored and accessible through access openings in the forward wing spar. The access openings in the forward spar can provide access for battery insertion and removal, as well as electrical and thermal management connections. Such forward spar access openings can be a relatively small, as the access opening need to only be as large as the battery cross section. A battery can comprise one or more battery modules based on the application requirements. The aircraft battery can be distributed among more, smaller battery modules. The battery modules can be placed in different locations in the wing. For example, the battery modules can be placed proximate an aircraft fuselage to achieve a better center of gravity.

### TECHNICAL FIELD

The present disclosure generally relates to aircraft batteries, and more specifically to a modular airfoil-shaped battery disposed in a wing of an aircraft.

### BACKGROUND

Modern aircraft rely more and more on electrical power, including hybrid aircraft and electric aircraft. Hybrid aircraft include combustible fuel and batteries to power aircraft systems. Electric aircraft require large batteries to power the aircraft's propulsion, communication, and control systems. Conventional aircraft place the batteries in the fuselage. However, such fuselage placement quickly consumes available fuselage space decreasing the aircraft's capacity to transport cargo or personnel. Although fuselage placement can provide for easy access to the batteries.

An aircraft must satisfy exacting standards regarding any aircraft component. Any aircraft component not satisfying such requirements can have a parasitic effect on the aircraft's performance or worse. For example, outfitting wing skins with removeable fasteners could bring about loose holes that would drive up aircraft weight significantly and provide potential failure points for wing malfunction. Also, repositioning the fasteners back into the holes may be nearly impossible given the different tensions acting on the wing skin.

### SUMMARY

The present disclosure achieves technical advantages as a modular airfoil-shaped battery disposed in a wing of an aircraft. In one embodiment, the present disclosure provides for a system configured to have batteries or battery modules stored and accessible through access openings in the forward wing spar. The access openings in the forward spar can provide access for battery insertion and removal, as well as electrical and thermal management connections. A machined spar can include one or more stiffeners and web thicknesses that can be added, tailored, and customized around holes. Such forward spar access openings can be a relatively small, as the access opening need to only be as large as the battery cross section. A battery can comprise one or more battery modules based on the application requirements. To further decrease the access opening size, the aircraft battery can be distributed among more, smaller battery modules. The battery modules can be placed in different locations in the wing. For example, the battery modules can be placed proximate an aircraft fuselage to achieve a better center of gravity. In another example, the battery modules can be placed distal to an aircraft fuselage to increase passenger safety.

The present disclosure solves the technological problem of providing storage and access to batteries stored in a wing of an aircraft. Aircraft wings can provide an ideal location to install batteries because wings may be allowed to break off in a crash as opposed to retaining items of mass in the fuselage for up to 20 Gs. However, utilizing the wing space for battery installation can be challenging due to the non-rectangular cross section. To solve this problem unique battery module shapes can be utilized. Further, massive battery installations in structural wing torque boxes have the problem of access to the batteries for maintenance or replacement. The present disclosure provides a technological solution missing from conventional systems by removing the location of aircraft batteries from the fuselage to increase space. Additionally, the present disclosure provides the technological benefit of not requiring that the wing skin be removed increasing the structural integrity of the wing and decreasing the aircraft maintenance time.

It is an object of the disclosure to provide a modular battery installation system. It is a further object of the disclosure to provide a method of installing a battery in a wing. It is a further object of the disclosure to provide a modular battery assembly. These and other objects are provided by the present disclosure, including at least the following embodiments.

In one embodiment, a modular battery installation system can include: an aircraft having a wing; a forward spar disposed within the wing and having a forward spar access opening; and a battery module removably insertable into the wing through the forward spar access opening. Further comprising an access panel configured to removably cover the forward spar access opening. Wherein the battery module includes a plurality of battery cells. Wherein the battery module includes a battery module shelf configured to support the battery module. Wherein the battery module shelf includes a rail operably coupled to the forward spar to allow the battery module to be slidably inserted into the wing. Wherein a plurality of battery modules can be electrically connected to form an aircraft battery. Wherein the plurality of battery cells can be stacked to contour to an airfoil shape of the wing. Wherein the battery module includes a battery management unit configured to control one or more battery module functions.

In another embodiment, a method of installing a battery in a wing can include: removing an access panel disposed over an access opening of a forward wing spar of an aircraft wing; inserting a battery module into the aircraft wing through the access opening; and disposing the access panel over the access opening of a forward wing spar. Further comprising removing a leading edge of a wing. Wherein the battery module includes a plurality of battery cells. Wherein the inserting step further includes disposing the battery module on a battery module shelf. Wherein the inserting step further includes sliding the battery module shelf into the wing via a rail. Wherein the plurality of battery cells can be positioned to at least partially contour at least a portion of an airfoil shape of the wing. Wherein the battery module includes a battery management unit configured to control one or more battery module functions.

In another embodiment, a modular battery assembly can include: an aircraft having a wing; and a plurality of battery cells disposed within the wing and positioned to at least partially contour to at least a portion of a wing shape. Wherein the battery cells are stair-stepped. Further comprising a battery bus disposed proximate a first end of the battery cells. Wherein the battery bus at least partially contours to at least a portion of the wing shape. Further comprising a battery module shelf configured to receive the battery cells.

### BRIEF DESCRIPTION OF THE DRAWINGS

The present disclosure will be readily understood by the following detailed description, taken in conjunction with the accompanying drawings that illustrate, by way of example, the principles of the present disclosure. The drawings illustrate the design and utility of one or more exemplary embodiments of the present disclosure, in which like elements are referred to by like reference numbers or symbols. The objects and elements in the drawings are not necessarily drawn to scale, proportion, or precise positional relationship. Instead, emphasis is focused on illustrating the principles of the present disclosure.

FIG. 1 is a perspective view of a tiltrotor aircraft, in accordance with one or more embodiments of the present disclosure;

FIG. 2A is a perspective view of a tiltrotor aircraft wing assembly, in accordance with one or more embodiments of the present disclosure;

FIG. 2B is a perspective view of a portion of a tiltrotor aircraft wing assembly, in accordance with one or more embodiments of the present disclosure.

FIG. 2C is a zoomed-in perspective view of a tiltrotor aircraft wing assembly showing a battery module in a wing, in accordance with one or more embodiments of the present disclosure.

FIG. 2D is a zoomed-in perspective view of a tiltrotor aircraft wing assembly showing a bayonet pin structure, in accordance with one or more embodiments of the present disclosure.

FIG. 3A is a perspective view of battery modules disposed in a wing covered by access panels, in accordance with one or more embodiments of the present disclosure.

FIG. 3B is a perspective view of battery modules disposed in a wing with the access panels removed, in accordance with one or more embodiments of the present disclosure.

FIG. 3C is a perspective view of one battery module partially removed and a second battery module disposed in a wing with the access panels removed, in accordance with one or more embodiments of the present disclosure.

FIG. 4A is a perspective view of a battery cell with leads on either end, in accordance with one or more embodiments of the present disclosure.

FIG. 4B is a perspective view of a battery cell with leads spaced horizontally on one end, in accordance with one or more embodiments of the present disclosure.

FIG. 4C is a perspective view of a battery cell with leads spaced vertically on one end, in accordance with one or more embodiments of the present disclosure.

FIG. 5 is a cross-sectional perspective view of a wing having a battery module, in accordance with one or more embodiments of the present disclosure.

FIG. 6A is a top view of a battery module in a wing, in accordance with one or more embodiments of the present disclosure.

FIG. 6B is a rear-left perspective view of a battery module in a wing, in accordance with one or more embodiments of the present disclosure.

FIG. 6C is a rear-right perspective view of a battery module in a wing, in accordance with one or more embodiments of the present disclosure.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. Pursuant to Section 904 of the Manual of Patent Examination Procedure, the Examiner, after having obtained a thorough understanding of the invention disclosed and claimed in the nonprovisional application has searched the prior art as disclosed in patents and other published documents. Therefore, as evidenced by the issuance of this patent, the prior art fails to disclose or teach the elements and limitations presented in the claims as enabled by the specification and drawings, such that the presented claims are patentable under 35 U.S.C. §§ 101, 102, 103, and 112.

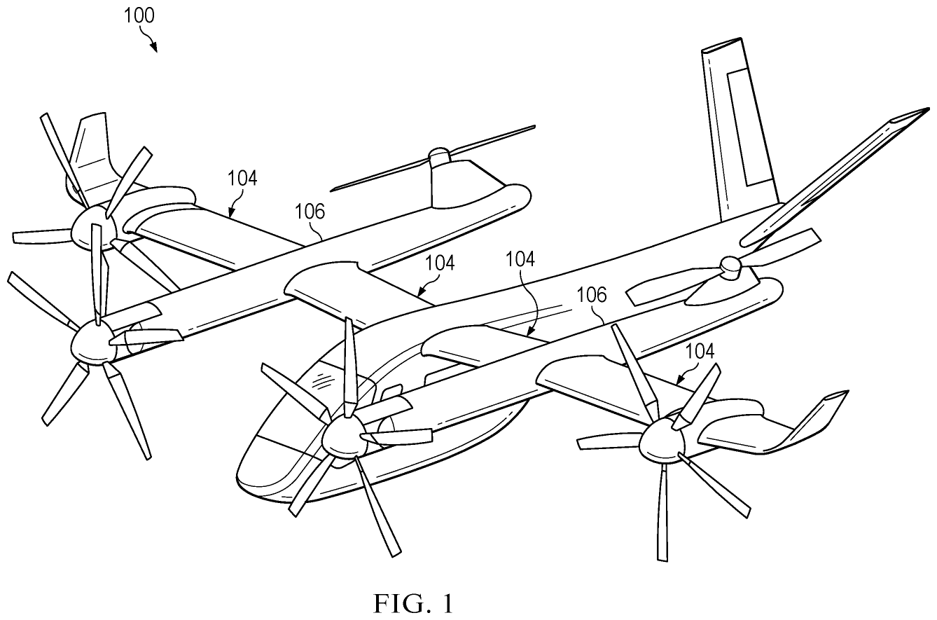

FIG. 1 is a perspective view of a tiltrotor aircraft 100, in accordance with one or more embodiments of the present disclosure. In one embodiment, a tiltrotor aircraft 100 can be convertible between a hover mode (commonly referred to as helicopter mode), which allows for vertical takeoff and landing, hovering, and low speed directional movement, and a forward flight mode (commonly referred to as airplane mode), which allows for forward flight as well as horizontal takeoff and landing. Aircraft 100 can include a fuselage, a wing 104, and booms 106 coupled to the wing on opposite sides of the fuselage. In another embodiment, the boom can be coupled to the wing at any point between the wing tip and the fuselage, such that the wing 104 can provide lift on both sides of the booms 106. In another embodiment, the aircraft 100 can include propulsion systems, such as forward propulsion systems adjacent to the forward end of the fuselage, aft propulsion systems adjacent to the aft end of the fuselage, and wing-mounted propulsion systems proximate the tips of wing 104, among others. In another embodiment, forward propulsion systems can be attached to forward ends of booms 106, and aft propulsion systems can be attached to proximate aft ends of booms 106.

In another embodiment, each forward propulsion system can include a drive system housing comprising a pylon and a rotatable open rotor assembly comprising a plurality of rotor blades connected to a rotor mast and configured to rotate about a rotor axis. each wing-mounted propulsion system can include a drive system housing comprising a pylon 130 and a rotatable open rotor assembly comprising a plurality of rotor blades connected to a rotor mast and configured to rotate about a rotor axis. In another embodiment, each pylon 130 can house one or more electric motors therein configured to produce rotational energy that drives the rotation of rotor assembly. In another embodiment, each pylon 130 can house a gearbox that drives the rotation of rotor assembly, wherein the gearbox receives rotational energy from a driveshaft.

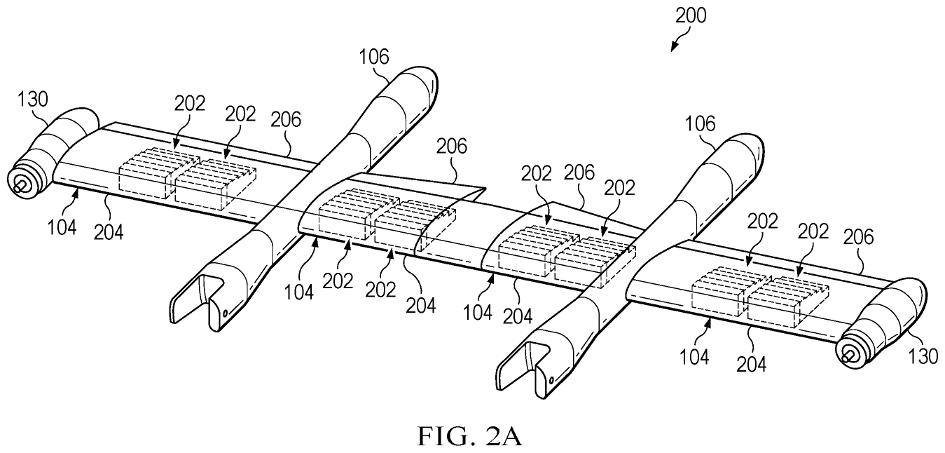

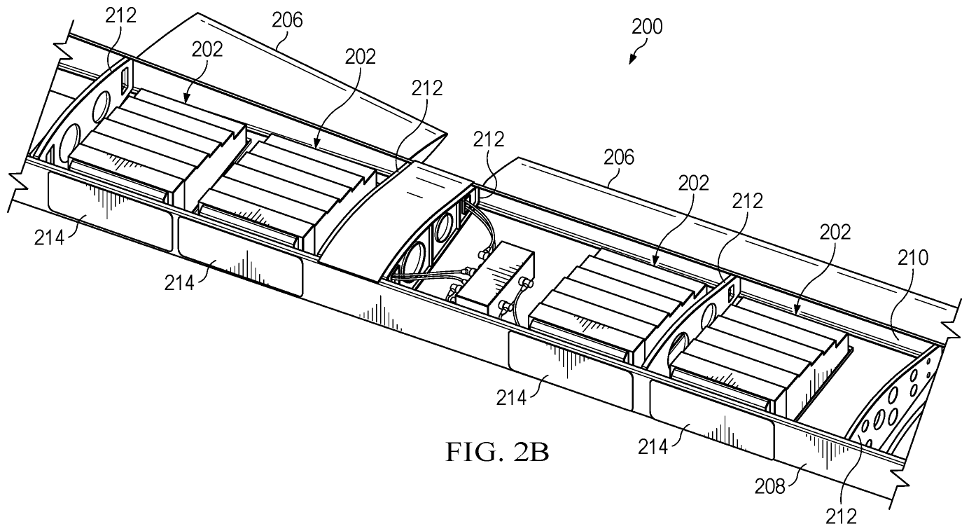

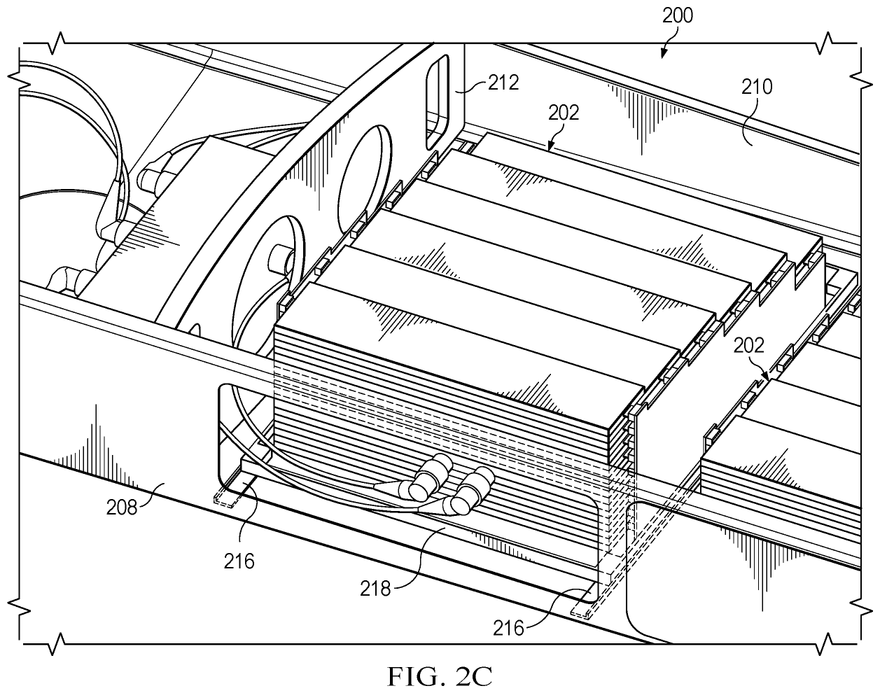

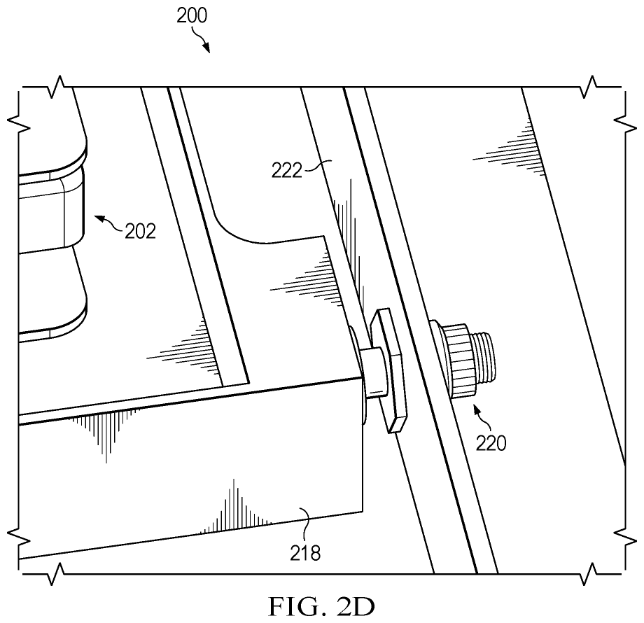

FIG. 2A is a perspective view of a tiltrotor aircraft wing assembly 200, in accordance with one or more embodiments of the present disclosure. In one embodiment, the Aircraft Wing Assembly 200 can include a wing 104, a boom 106, and a pylon 130. The wing 104, can include a wing leading edge 204 and a wing trailing edge 206. In another embodiment, the wing leading edge 204 can be removably coupled to the wing 104 via a securing system. For example, the securing system can include bolts, nuts, fasteners, hinges, or other suitable securing mechanism for coupling the wing leading edge 204 to the wing 104. In another embodiment, the wing leading edge 204 can include a leading-edge device. For example, the leading-edge device can be a cuff, flap, or other suitable component. In another embodiment, the wing trailing edge 206 can be removably coupled to the wing 104 via a securing system. For example, the securing system can include bolts, nuts, fasteners, hinges, or other suitable securing mechanism for coupling the wing trailing edge 206 to the wing 104. In another embodiment, the wing trailing edge 206 can include a trailing-edge device. For example, the trailing-edge device can be a cuff, flap, or other suitable component. One or more battery modules 202 can be disposed within the wing 104.

FIG. 2B is a perspective view of a portion of a tiltrotor aircraft wing assembly 200 with the wing leading edge 204, boom 106, and pylon 130 removed, in accordance with one or more embodiments of the present disclosure. In another embodiment, the wing can include a plurality of battery modules 202, a wing trailing edge 206, a forward wing spar 208, an aft wing spar 210, a wing rib 212, and an access panel 214. With the wing leading edge removed, the forward wing spar 208 can be accessed without manipulation of the wing skin. The forward wing spar 208 can include an access panel 214.

FIG. 2C is a perspective view of a portion of tiltrotor aircraft wing assembly 200 showing a battery module in a wing, in accordance with one or more embodiments of the present disclosure. In one embodiment, the forward wing spar 208 can include a battery module shelf 218 configured to receive a battery module 202. For example, the battery module can be secured to the battery module shelf 218 via a bolt, nut, rivet, latch, or other suitable device. The battery module shelf 218 can include a battery module rail 216 operatively coupled to at least a portion of one side of the battery module shelf 218. For example, the battery module rail 216 can allow the battery module shelf 218 to slide along the battery module rail to position the battery module 202 inside or outside the wing through the forward wing spar access opening. In another embodiment, the retention bar can prevent the battery module 202 from being removed from the wing. In another embodiment, the retention bar can prevent the displacement of the battery module shelf 218 along the battery module rail 216. The retention bar can include a retention fastener configured to disengage the retention bar to allow displacement of the battery module 202. For example, the retention fastener can be a bolt, nut, rivet, latch, knob, or other suitable device. The battery module 202 can be disposed between the forward wing spar 208 and an aft wing spar 210.

FIG. 2D is a zoomed-in perspective view of a tiltrotor aircraft wing assembly showing a bayonet pin structure, in accordance with one or more embodiments of the present disclosure. In one embodiment, the battery module rail 216 can be operably coupled to the forward wing spar 208. For example, the rails can be secured to the forward wing spar 208 via a bolt, nut, rivet, latch, or other suitable device. In another embodiment, the battery module rail 216 may be unattached at the distal end from the forward wing spar 208. In another embodiment, the battery module rail 216 may be coupled to a wing support member 222 at the distal end from the forward wing spar 208. In another embodiment, the wing support member 222 can be coupled to the aft wing spar 210. In another embodiment, the distal end of the battery module rail 216 can be coupled to the aft wing spar 210. In another embodiment, the distal end of the battery module rail 216 can be coupled to the aft wing spar 210 or the wing support member 222 via a bayonet pin assembly 220. In another embodiment, the distal end of the battery module shelf 218 can be coupled to the aft wing spar 210 or the wing support member 222 via a bayonet pin assembly 220. For example, the bayonet pin assembly 220 can include a bayonet pin male member and a bayonet pin female member configured to receive and retain the bayonet pin male member. The bayonet pin assembly 220 can provide additional weight-bearing support for the battery module 202 without requiring aft access to the wing.

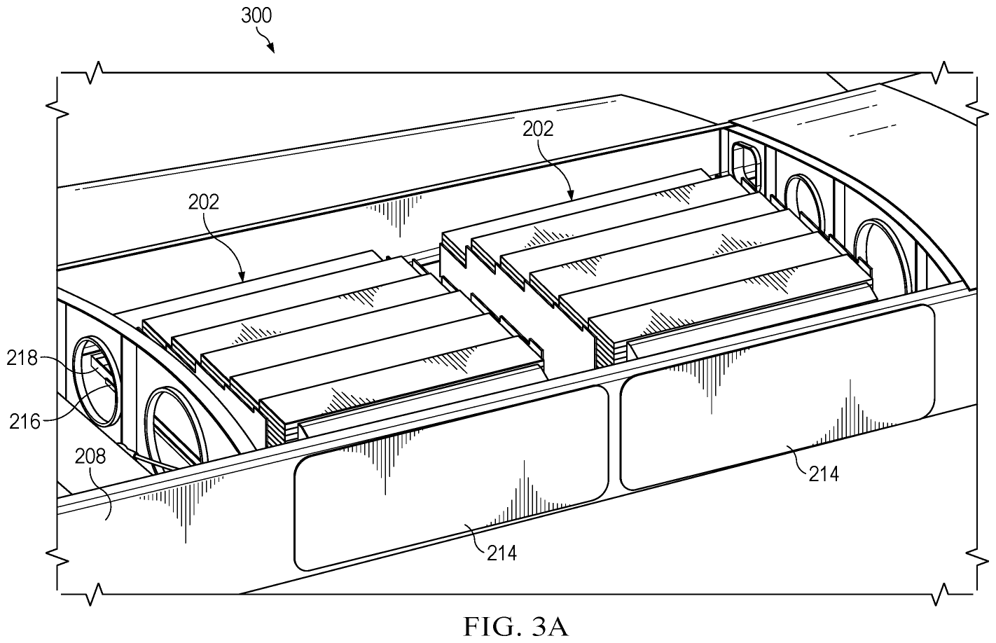

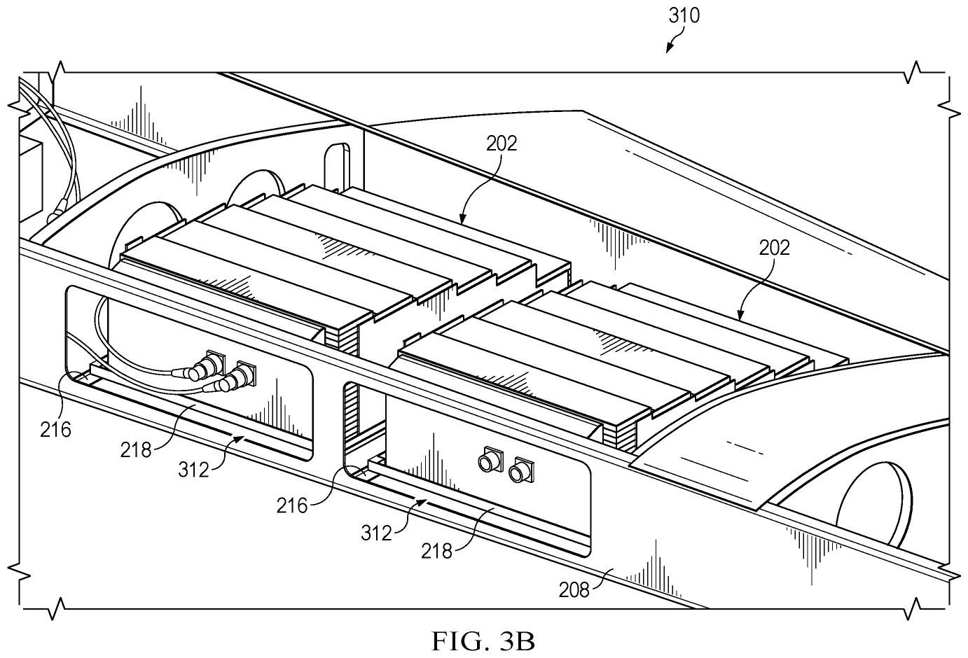

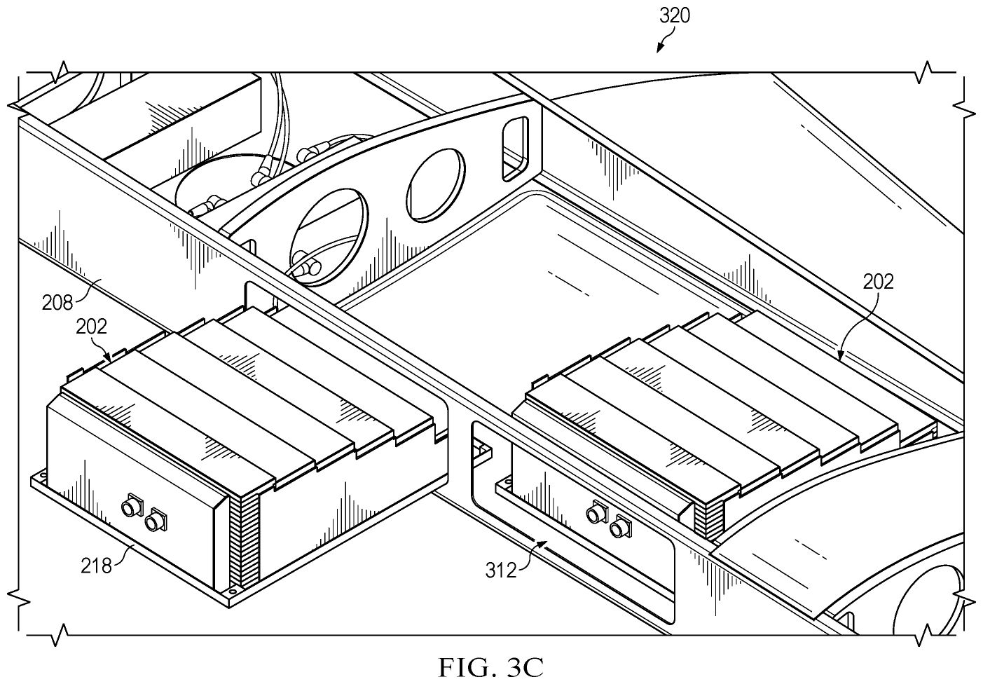

FIG. 3A is a perspective view 300 of battery modules 202 disposed in a wing having access panels 214 covering forward wing spar access openings, in accordance with one or more embodiments of the present disclosure. In one embodiment, battery modules 202 can be disposed on a battery module shelf 218 within a wing. The retention fastener can secure the battery in place, such that the battery module rail 216 will not function to displace the battery. For example, the wing fastener can be a bolt threaded through a hole in both the batter module shelf 218 an the battery module rail 216, such that the battery module shelf 218 cannot slide along the battery module rail 216. In another embodiment, the battery module rail can have a top flange and a bottom flange to receive the battery module shelf therebetween, to prevent the battery module shelf 218 from disengaging the battery module rail 216. The battery module rail may also include one or more bearings to facilitate smooth sliding of the battery module shelf 218 along the battery module rail 216. The access panel 214 can be secured over the forward wing spar access opening via a bolt, nut, rivet, latch, knob, hinge, or other suitable device or combination thereof, operably coupled to the forward wing spar 208 and the access panel 214.

FIG. 3B is a perspective view 310 of battery modules 202 disposed in a wing with the access panels removed, in accordance with one or more embodiments of the present disclosure. In one embodiment, battery modules 202 can be removed from the wing by removing the wing leading edge then removing the access panels disposed on the forward wing spar 208. The retention fastener can be removed to allow the battery module shelf 218 to slide along the battery module rail 216 to displace the battery module 202 out of the wing through the forward wing spar access opening 312, as shown in FIG. 3C. FIG. 3C is a perspective view 320 of one battery module partially removed and a second battery module disposed in a wing with the access panels removed, in accordance with one or more embodiments of the present disclosure.

In another embodiment, the battery module 202 coupled to the battery module shelf 218 can be removed from the battery module rail 216. In another embodiment, the battery module 202 can be decoupled from the battery module shelf 218, which can remain slidably coupled with the battery module rail 216. A new battery module 202 can then be coupled with the battery module shelf 218 and displaced (e.g., slid on the battery module rails 216) into the wing. In another embodiment, an actuator disposed within the wing can displace the battery module 202 into and out of the wing. The retention fastener can be reaffixed to secure the battery in place, such that the battery module rail 216 will not function to displace the battery module 202. The access panels can then be recoupled to the forward wing spar 208 and the wing leading edge 204 can be coupled to the forward wing spar 208. In another embodiment, inside the wing skin, the lower skin can curve away from the from the bottom of the battery or the top of the bottom skin can be flat. In another embodiment, the battery module 202 can be placed directly on top of the flat bottom skin. For example, a battery module rail and a battery module shelf can be optional. In another embodiment, the battery module 202 could be inserted through the forward wing spar access opening 312 so the battery module 202 can sit right on the wing skin instead of hanging and being suspended. For example, when the battery module 202 is placed directly on the bottom wing skin it can be supported by the bottom wing skin.

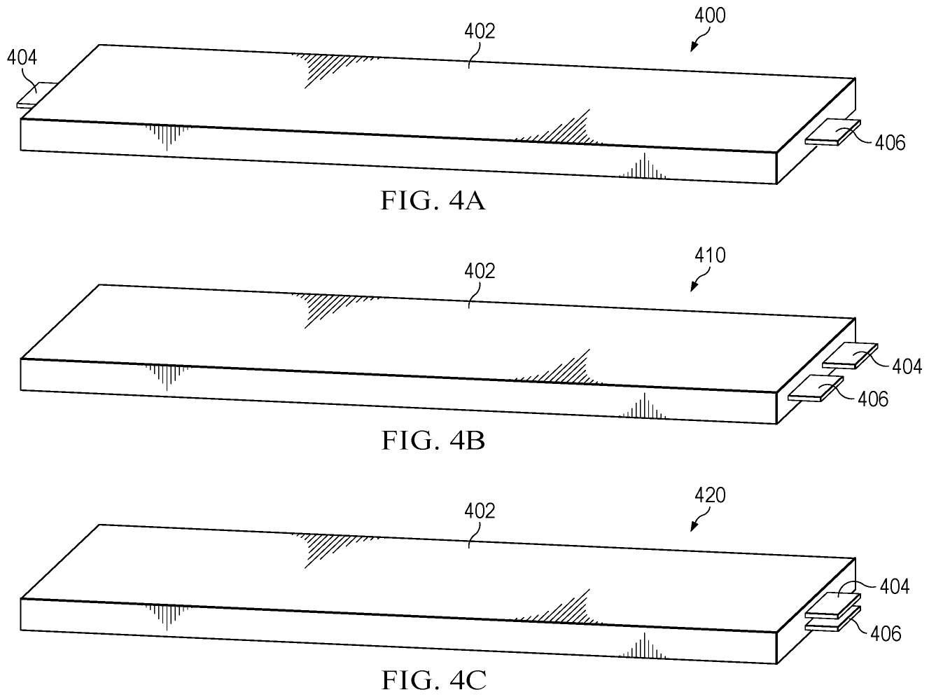

FIGS. 4A-4C show battery cells having leads in different configurations. FIG. 4A is a perspective view of a battery cell 400 with leads on either end, in accordance with one or more embodiments of the present disclosure. FIG. 4B is a perspective view of a battery cell 410 with leads spaced horizontally on one end, in accordance with one or more embodiments of the present disclosure. FIG. 4C is a perspective view of a battery cell 420 with leads spaced vertically on one end, in accordance with one or more embodiments of the present disclosure. In one embodiment a battery cell 400, 410, 420 can have a cell body 402, a positive lead 404, and a negative lead 406. For example, a battery cell can be a GM® Ultium® battery, a Tesla® 18650, 20700, 21700, or other suitable battery cell. In another embodiment, the cell body 402 can be of any type, including wet cell or dry cell, with any chemistry, including lithium ion, alkaline, or nickel metal hydride (NIMH), to name a few. In another embodiment, each battery cell 400, 410, 420 can include a positive terminal 404 and a negative terminal 406 configured to engage a load. Each terminal 404, 406 can be configured to engage a battery bus to aggregate the electric potential to suit a particular application. In one embodiment multiple battery cells 400, 410, 420 can be aggregated to form a battery module. In another embodiment, a battery can be comprised of two or more battery modules 202. In another embodiment, the PCB board can include a bus, a balancer, and a battery management system. In another embodiment, the battery modules 202 can be interconnected to generate a greater voltage and provide redundancy in the event a battery module 202 fails. In another embodiment, a Power Distribution Panel (PDP) can be coupled to one or more batteries to aggregate, attenuate, and distribute power to one or more aircraft components. For example, the PDP can provide redundant electrical paths to the to the electric motors.

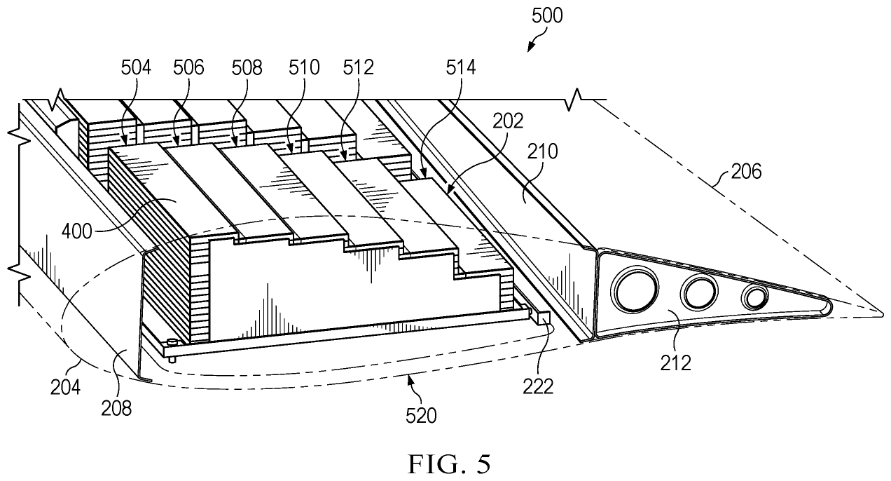

FIG. 5 is a cross-sectional perspective view of a wing having a battery module 500, in accordance with one or more embodiments of the present disclosure. In one embodiment, an airfoil, such as a wing, can include a wing leading edge 204 and a wing trailing edge 206, to create an airfoil shape 520. Between the forward wing spar 208 and the aft wing spar 210, a battery module 202 can be disposed within the wing. The battery module 202 can be disposed on a battery module shelf. In one embodiment, the battery module shelf can have one or more legs configured to sit on the top of a bottom wing skin. A rear support member 222 can be positioned within the wing to provide a stop to position the battery module within the wing and limit its movement within the wing.

In another embodiment, the battery module 202 can include a plurality of battery cells 400 disposed within the wing and positioned to at least partially contour to at least a portion of the airfoil (e.g., wing) shape. In one embodiment, a plurality of battery cells 400 can be stacked vertically. For example, the battery cells can be stacked to a height that allows insertion and removal through the forward wing spar access opening. In another embodiment, the battery cells 400 can be stacked into a plurality of battery cell columns 504, 506, 508, 510, 512, 514 to conform to the airfoil contour within the airfoil. For example, as the height of the airfoil decreases from the forward wing spar 208 to the aft wing spar 210, the battery cell columns can have a corresponding decrease in height by stacking fewer battery cells 400 in a battery cell column (e.g., stair-stepping the plurality of battery cell columns 504, 506, 508, 510, 512, 514). In this way, by non-limiting example, a first battery cell column 504 can have eighteen battery cells 400 stacked on top of each other, a second battery cell column 506 can have seventeen battery cells 400 stacked on top of each other, a third battery cell column 508 can have sixteen battery cells 400 stacked on top of each other, a fourth battery cell column 510 can have fourteen battery cells 400 stacked on top of each other, a fifth battery cell column 512 can have twelve battery cells 400 stacked on top of each other, and a sixth battery cell column 514 can have eight battery cells 400 stacked on top of each other. Accordingly, the cell height can match any internal airfoil height by varying the number of battery cells 400 stacked in a particular battery cell column. In one embodiment, the number of battery cell columns and the number of battery cells are only limited by the battery cell size and the internal airfoil area. In another embodiment, the battery module 202 can continue through an aft wing spar access opening into at least a portion of a wing trailing edge 206. In another embodiment, the battery module can abut a wing rib 212 for added support, including vertical and horizontal stabilization. In another embodiment, a battery bus can be disposed proximate a first end of the battery cells. For example, the battery bus can at least partially contour to at least a portion of the wing shape. In another embodiment, the battery bus can have at least a portion of the cross-sectional area of the battery module 202. In another embodiment, each battery module can include a titanium battery cover to aid in dispersing heat.

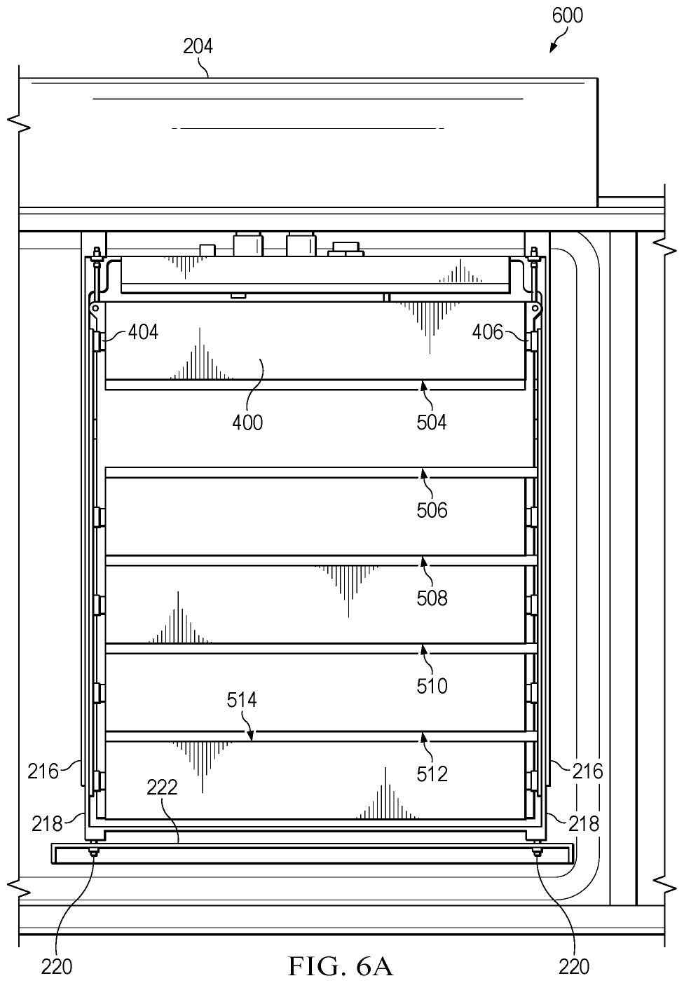

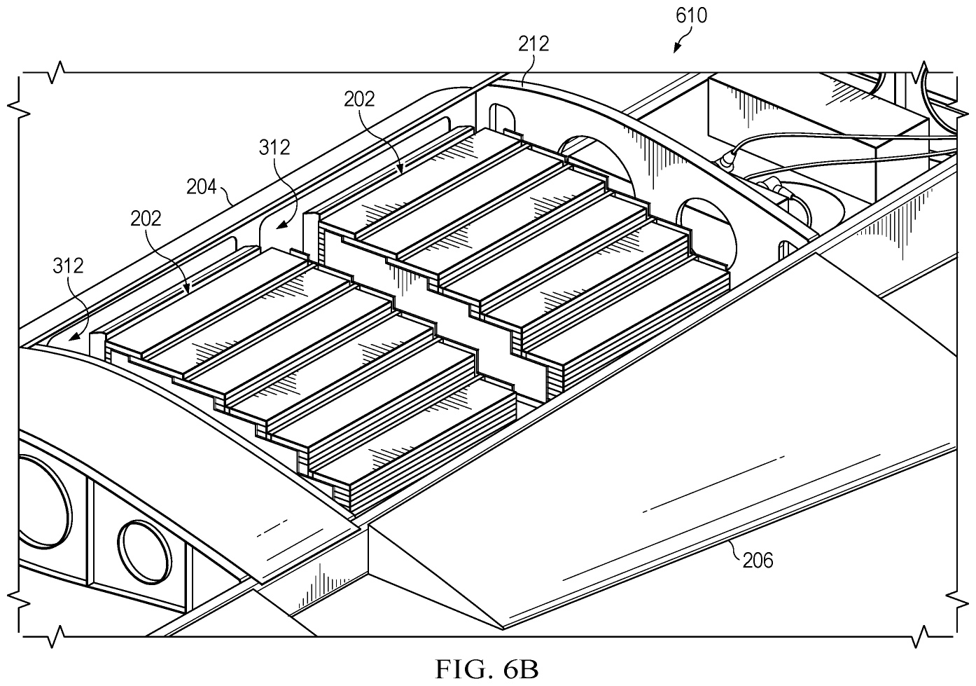

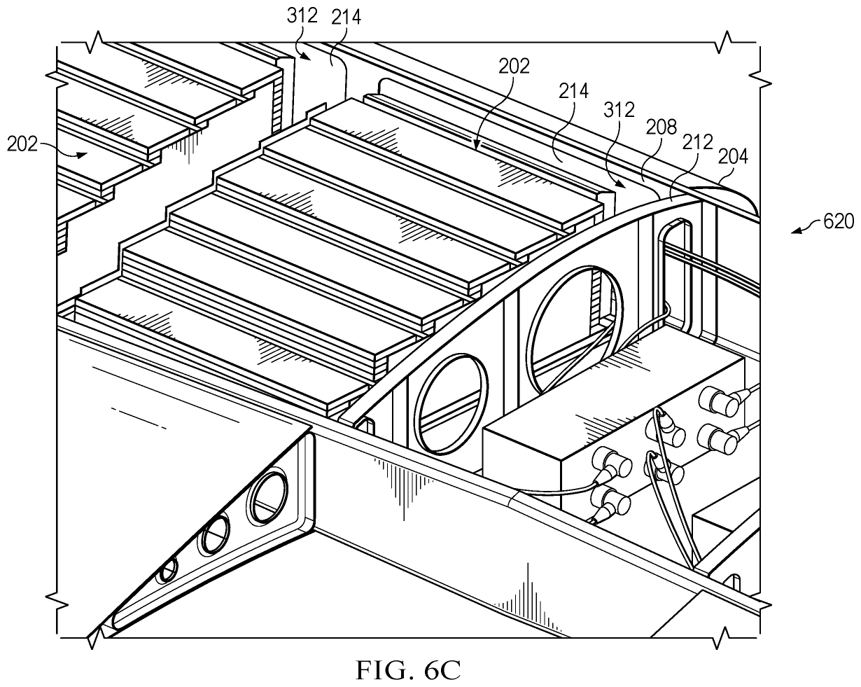

FIGS. 6A-6C show different views of a battery module disposed within a wing, with the access panel 214 disposed over the forward wing spar access opening 312 and the wing leading edge 204 coupled to the forward wing spar 208. FIG. 6A is a top view 600 of a battery module in a wing, in accordance with one or more embodiments of the present disclosure. FIG. 6B is a rear-left perspective view 610 of a battery module in a wing, in accordance with one or more embodiments of the present disclosure. FIG. 6C is a rear-right perspective view 620 of a battery module in a wing, in accordance with one or more embodiments of the present disclosure.

Persons skilled in the art will readily understand that advantages and objectives described above would not be possible without the particular combination of computer hardware and other structural components and mechanisms assembled in this inventive system and described herein.

The description in this patent document should not be read as implying that any particular element, step, or function can be an essential or critical element that must be included in the claim scope. Also, none of the claims can be intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f). Even under the broadest reasonable interpretation, in light of this paragraph of this specification, the claims are not intended to invoke 35 U.S.C. § 112(f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the inventions can be established by the appended claims rather than by the foregoing description. The scope of the claims can include one, some, or portions of any of the embodiments disclosed herein, either alone or in combination. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

What is claimed is:

1. A modular battery installation system, comprising:
an aircraft having a wing;
a forward spar disposed within the wing and having a forward spar access opening; and
a battery module removably insertable into the wing through the forward spar access opening.

2. The system of claim 1, further comprising an access panel configured to removably cover the forward spar access opening.

3. The system of claim 1, wherein the battery module includes a plurality of battery cells.

4. The system of claim 1, wherein the battery module includes a battery module shelf configured to support the battery module.

5. The system of claim 4, wherein the battery module shelf includes a rail operably coupled to the forward spar to allow the battery module to be slidably inserted into the wing.

6. The system of claim 1, wherein a plurality of battery modules can be electrically connected to form an aircraft battery.

7. The system of claim 3, wherein the plurality of battery cells can be stacked to contour to an airfoil shape of the wing.

8. The system of claim 1, wherein the battery module includes a battery management unit configured to control one or more battery module functions.

9. A method of installing a battery in a wing, comprising:
removing an access panel disposed over an access opening of a forward wing spar of an aircraft wing;
inserting a battery module into the aircraft wing through the access opening; and
disposing the access panel over the access opening of a forward wing spar.

10. The method of claim 9, further comprising removing a leading edge of a wing.

11. The method of claim 9, wherein the battery module includes a plurality of battery cells.

12. The method of claim 9, wherein the inserting step further includes disposing the battery module on a battery module shelf.

13. The method of claim 12, wherein the inserting step further includes sliding the battery module shelf into the wing via a rail.

14. The system of claim 11, wherein the plurality of battery cells can be positioned to at least partially contour at least a portion of an airfoil shape of the wing.

15. The system of claim 9, wherein the battery module includes a battery management unit configured to control one or more battery module functions.

16. A modular battery assembly, comprising:
an aircraft having a wing; and
a plurality of battery cells disposed within the wing and positioned to at least partially contour to at least a portion of a wing shape.

17. The assembly of claim 16, wherein the battery cells are stair-stepped.

18. The assembly of claim 16, further comprising a battery bus disposed proximate a first end of the battery cells.

19. The assembly of claim 18, wherein the battery bus at least partially contours to at least a portion of the wing shape.

20. The assembly of claim 16, further comprising a battery module shelf configured to receive the battery cells.
